(19) United States
(12) Patent Application Publication
(10) Pub. No.: US 2014/0349727 A1
(43) Pub. Date: Nov. 27, 2014

(54) METHODS AND SYSTEMS FOR DATA PRESENTATION ON A USER INTERFACE

(71) Applicant: TENCENT TECHNOLOGY (SHENZHEN) COMPANY LIMITED, Shenzhen (CN)

(72) Inventors: YIJU MOU, Shenzhen (CN); JUN LI, Shenzhen (CN); XIN WANG, Shenzhen (CN); LIANG SHANG, Shenzhen (CN); ZHUO GONG, Shenzhen (CN); ZHIYONG ZHUO, Shenzhen (CN)

(73) Assignee: TENCENT TECHNOLOGY (SHENZHEN) COMPANY

(21) Appl. No.: 14/315,375

(22) Filed: Jun. 26, 2014

Related U.S. Application Data
(63) Continuation of application No. PCT/CN2014/073760, filed on Mar. 20, 2014.

(30) Foreign Application Priority Data
May 22, 2013 (CN) 201310193101.0

(51) Int. Cl. G07F 17/32; G06F 3/0481

(52) U.S. Cl. CPC G07F 17/3293; G06F 3/0481
USPC 463/13; 715/738

(57) ABSTRACT

A method and system for presenting data elements on a user interface are disclosed. The method includes determining a data attribute of a data element, the data attribute being a primary data attribute or a non-primary data attribute; identifying the data element based on the data attribute; and displaying the data element based on the identification of the data attribute. The method and system may improve the user experience by providing better visual distinctions between different groups of data elements.

### CROSS-REFERENCES TO RELATED APPLICATIONS

### Related Applications

This application is a continuation application of PCT Patent Application No. PCT/CN2014/073760, filed on Mar. 20, 2014, which is based upon and claims the benefit of priority from Chinese Patent Application No. 201310193101.0, filed on May 22, 2013, the entire contents of which are incorporated herein by reference.

### FIELD OF THE INVENTION

The present disclosure relates to Internet technologies and, more particularly, to methods and systems for data presentation on a user interface.

### BACKGROUND

With the development of network related technologies and smart devices, users often use smart devices to exchange data with network service platforms. Different types of data have different characteristics. Software applications may identify attributes for different types of data to better facilitate data processing and presentation. For example, based on application environments, a software application may identify certain data attributes as primary data attributes and other attributes as non-primary data attributes. Further, the application may present the data based on the data attributes.

Often, when presenting data, a software application may determine the position of a data presentation based on a data attribute. In one example, an application may present all data with certain primary data attributes on the left side of a user interface. The application may present data with certain non-primary data attributes on the right side of the user interface. Further, the application may display the data with the non-primary data attributes in random sequence.

In the above example, if a user is not aware of the method used to present the data, the user may not be able to identify the attributes associated with the data presentation. In addition, if only a few data elements are displayed, it would also be difficult for a user to identify the attributes associated with the displayed data elements. As a result, the user may have difficulty fully understanding the presented data.

The disclosed method and system are directed to solve one or more problems set forth above and other problems.

### BRIEF SUMMARY OF THE DISCLOSURE

Embodiments consistent with the present disclosure provide a method, system, mobile device, or a server for presenting data on a user interface. Embodiments consistent with the present disclosure provide more information about the presented data to a user.

One aspect of the present disclosure provides a method for presenting data elements on a user interface. The method includes determining a data attribute of a data element, the data attribute being a primary data attribute or a non-primary data attribute; identifying the data element based on the data attribute; and displaying the data element based on the identification of the data attribute.

Another aspect of the present disclosure provides a system for presenting data elements on a user interface. The system includes a determination module configured to determine a data attribute of a data element, the data attribute being a primary data attribute or a non-primary data attribute; an identification module configured to identify the data element based on the data attribute; and a display module configured to display the data element based on the identification of the data attribute.

Another aspect of the present disclosure provides a system for presenting poker cards on a user interface of an online poker game. The system includes a determination module configured to determine a data attribute of a poker card data element, the data attribute being a trump suit or one of other suits; an identification module configured to identify the poker card data element based on the data attribute; and a display module configured to display the poker card data element based on the identification of the data attribute.

Embodiments consistent with the present disclosure identify data elements based on their attributes, and then present the data elements showing different identifications of the data attributes. Embodiments consistent with the present disclosure may thus display data elements with different attributes with distinction, and improve the accuracy of user data recognition.

Other aspects of the present disclosure can be understood by those skilled in the art in light of the description, the claims, and the drawings of the present disclosure.

### BRIEF DESCRIPTION OF THE DRAWINGS

To illustrate embodiments of the invention, the following are a few drawings illustrating embodiments consistent with the present disclosure.

FIG. 1 is a flowchart of a method for presenting data on a user interface implemented by an exemplary embodiment consistent with the present disclosure;

FIG. 2 is another flowchart of a method for presenting data on a user interface implemented by an exemplary embodiment consistent with the present disclosure;

FIG. 3 is an exemplary user interface displaying data on a user interface implemented by an embodiment consistent with the present disclosure;

FIG. 4 is another exemplary user interface displaying data on a user interface implemented by an embodiment consistent with the present disclosure;

FIG. 5 is a schematic diagram of an exemplary system for presenting data on a user interface consistent with the present disclosure;

FIG. 6 is another schematic diagram of an exemplary system for presenting data on a user interface consistent with the present disclosure; and

FIG. 7 is an exemplary online computer environment.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

In the present disclosure, a mobile device, a terminal, a user terminal, and a terminal device are used interchangeably to refer to any computing device that may communicate with another computing device. Exemplary terminals may include laptop computers, smartphones, tablet computers, etc.

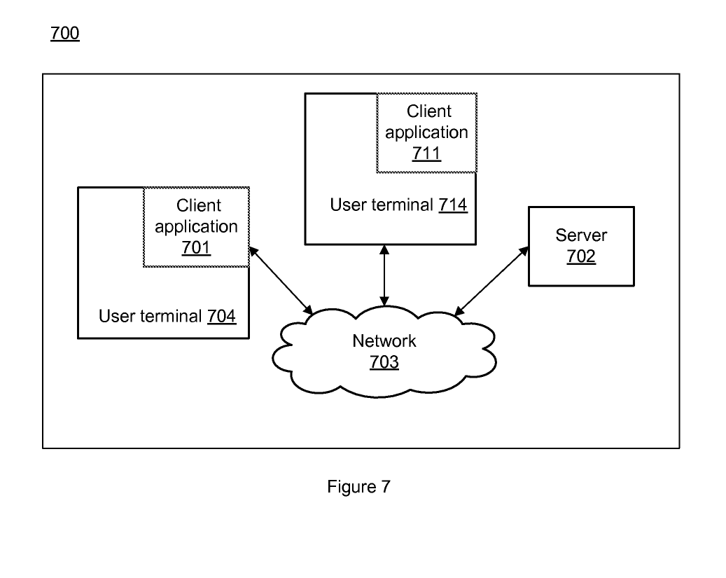

FIG. 7 illustrates an exemplary online computer environment 700 incorporating certain disclosed embodiments. As shown in FIG. 7, environment 700 may include user terminals 704 and 714, a network 703, and a server 702. The network 703 may include any appropriate type of communication network for providing network connections to the user terminals 704 and 714, and the server 702. For example, network 703 may include the Internet, LAN (Local Area Network), or other types of computer networks or telecommunication networks, either wired or wireless.

A server 702, as used herein, may refer to one or more server computers configured to provide certain functionalities, which may require any user accessing the services to authenticate to the server before the access. The server 702 may also include one or more processors to execute computer programs in parallel. The server 702 may include any appropriate server computers configured to provide certain server functionalities, such as storing or processing data related to displaying data elements on a user interface. Although only one server is shown, any number of servers can be included. The server 702 may operate in a cloud or non-cloud computing environment.

User terminals 704 and 714 may include any appropriate type of network computing devices, such as PCs, tablet computers, smartphones, network TVs, etc. User terminals 704 and 714 may include one or more client applications 701 and 711. The client applications 701 and 711, as used herein, may include any appropriate software application, hardware application, or a combination thereof to achieve certain client functionalities, such as playing a poker game online. For example, client applications 701 and 711 may be the Internet Explorer application, which may access websites and webpages. Any number of client applications 701 and 711 may be included in the environment 700.

User terminals 704/714 and server 702 may be implemented on any appropriate computing platform. FIG. 6 illustrates an exemplary terminal device 600 that can be used to implement embodiments consistent with the present disclosure. The terminal device 600 may include an RF circuit 110, one or more computer readable storage medium memory 120, an input unit 130, a display unit 140, a sensor 150, an audio circuit 160, a transmission module 170, one or more processors 180, and a power source 190. It is apparent that the terminal device 600 described in relation to FIG. 6 is exemplary, and does not limit the scope of the present disclosure. A terminal device consistent with the present disclosure may include fewer or more components or different components.

The RF circuit 110 may send and receive data, and/or receive and transmit signals. In particular, after receiving downlink data from a base station, the RF circuit 110 may send the data to processors 180 for further processing. Further, the RF circuit 110 may transmit uplink data to the base station. Usually, the RF circuit 110 includes, but is not limited to, an antenna, at least one amplifier, a tuner, one or more oscillators, a transceiver, a coupler, a Low Noise Amplifier (LNA), a duplexer, etc. In addition, the RF circuit 110 may also communicate with other wireless communication devices and networks. The wireless communication may use any communication standard or protocol, including GSM (Global System of Mobile communication), GPRS (General Packet Radio Service), CDMA (Code Division Multiple Access), WCDMA (Wideband Code Division Multiple Access), LTE (Long Term Evolution), email, SMS (Short Messaging Service), etc.

The memory 120 may store software programs and modules, such as the data presentation software programs and modules used to implement the embodiments of the present disclosure. The processor 180 may execute the software programs and modules stored in memory 120 to implement functions supporting the data presentation functions consistent with the present disclosure. The memory 120 may include a program storage area and a data storage area. The program storage area may store operating systems, one or more software applications (e.g., for audio or broadcasting functions). The data storage area may include data generated and/or used by terminal 600 (e.g., audio or video data). In addition, the memory 120 may include high speed random access memory, non-volatile memory, such as at least one disk storage device, a flash memory device, or other nonvolatile devices. The memory 120 may also include a memory controller, which manages the interactions between the memory 120, the processor 180, and the input unit 130.

The input unit 130 may receive numerical or character data input. The input unit 130 may include components such as keyboards, mice, control bars, optical track balls, touch screens, etc. In particular, the input unit 130 may include a touch screen 131 and the related input devices 132. The touch screen 131 may collect user input from its touch screen surface (e.g., fingers, stylus contact touch screen 131 or its vicinity). The input unit 130 may then initiate the operations of the relevant components based on the input. In one example, the touch screen 131 may include a touch detection means and a touch controller. The touch detection means may check location of the user's touches, detect the signals triggered by the touch motions, and send the signals to the touch controller. The touch controller may receive signals from the touch detection means and convert the signals into contact coordinates, send the contact coordinates to the processor 180, and receive and execute instructions from processor 180. The touch screen 131 may use a variety of resistive, capacitive, infrared and surface acoustic wave touch-sensitive surfaces 131. In addition to the touch screen 131, the input unit 130 may include other input devices 132. In particular, other input devices 132 may include but are not limited to physical keyboards, function keys, track balls, mice, operation bars, etc.

The display unit 140 may display a user's input or act as a graphic interface to present data to the users of terminal 600. The graphic interface may include graphics, texts, icons, videos, or combinations thereof. The display unit 140 may include a display panel 141. The display panel may be an LCD, LED, or OLED display. Further, the touch screen 131 may cover the display panel 141. When the touch screen 131 detects contacts on its screen or the vicinity, the touch screen 131 may send the data to the processor 180 to identify the category of the touch contact. The processor 180 may present visual output on the display panel 141 based on the category of the touch contact. In FIG. 6, the touch screen 131 and the display panel 141 are presented as two components for input and output functions. In other embodiments, the touch screen 131 and the display panel 141 may be combined to implement certain input and output functions.

The terminal 600 includes the sensor 150, which may be an optical sensor, a motion sensor, or other sensors. In particular, an optical sensor may include an ambient light sensor and a proximity sensor. The ambient light sensor may adjust the brightness of the display panel 141 based on the brightness of the ambient light. The proximity sensor may turn off the display panel 141 or its backlight when the terminal 600 is place close to a user's ear. As a type of motion sensor, the gravity acceleration sensor may detect the acceleration in all directions. When an object is still, the gravity acceleration sensor may detect the magnitude and direction of gravity. This can be used to recognize the position of a smartphone (for functions such as switching screen directions, gyro calibration gestures, etc.) and vibrations (for functions such as pedometer, tapping, etc.). The terminal 600 may also include a gyroscope, an air pressure sensor, a temperature sensor, an infrared sensor, and other sensors, which are not discussed here.

The audio circuit 160, a speaker 161, and a microphone 162 may provide the audio user interface between a user and the terminal 600. The audio circuit 160 may send the signals converted from the received audio data to the speaker 161. The speaker 161 may convert the signals to audio signals and output them. The speaker 161 may receive audio signals and convert them to electric signals. These electric signals may be received by the audio circuit 160, and be converted to audio data. The output processor 180 may process the audio data and send the data to another terminal through the RF circuit 110. The output processor 180 may also send the audio data to memory 120 to be further processed. The audio circuit 160 may include a microphone 162, which may enable an external ear phone to connect with the terminal 600.

The terminal 600, through the transmission module 170, may enable a user to send and receive emails, browse the Internet, and watch streaming media, etc. The transmission module 170 may facilitate fixed wire and wireless broadband connections to the Internet. The terminal 600 may chose not to include the transmission module 170 based on the specific needs of the embodiments.

The processor 180 is the control center of the terminal 600. The processor 180 uses interfaces and connections throughout the components of the terminal to operate the software programs stored in memory 120, to process the data stored in memory 120, and to implement the functions of terminal 600. The processor 180 may include one or more core processors. The processor 180 may integrate an application processor and a wireless communication processor. The application processor may control the operation system, user interface, and application programs. The wireless communication processor may control the wireless communications. The wireless communication processor may also be outside the processor 180.

The terminal 600 may include the power source 190 (e.g., battery). The power source 190 may use a power management system to connect with processor 180. The power management system may manage the charging, discharging, and other power management functions. The power source 190 may include one or more DC or AC power sources, charging systems, a power failure detection circuit, a power converter or inverter, and a power status indicator.

Even though not shown in FIG. 6, the terminal 600 may include a camera, a blue tooth module, etc., which are not discussed here. In embodiments consistent with the present disclosure, a user terminal may have a touch screen display. The user terminal may include a memory, one or more software programs stored in the memory. The user terminal may further include one or more processors to execute one more programs to implement the following functions.

The user terminal for data presentation may identify attributes of the data to be presented. The attributes may be primary data attributes or non-primary data attributes. The user terminal for data presentation may mark the data based on the attributes. The user terminal may present the data based on the markers.

In some embodiments consistent with the present disclosure, if one data element has a primary data attribute, then the user terminal may add a primary data attribute identification to the data element. If one data element has a non-primary data attribute, then the terminal may chose not to add any identification to the data element.

In other embodiments consistent with the present disclosure, if one data element has a non-primary data attribute, then the user terminal may add a non-primary data attribute identification to the data element. If one data element has a primary data attribute, then the terminal may chose not to add any identification to the data element.

In other embodiments consistent with the present disclosure, if one data element has a non-primary data attribute, then the user terminal may add a non-primary data attribute identification to the data element. If one data element has a primary data attribute, then the terminal may add a primary identification to the data element.

Further, primary data attributes may include persistent primary data attribute and variable primary data attribute. If a data element has a primary data attribute, then the user terminal for data presentation may determine whether the primary data attribute is a persistent primary data attribute or a variable primary data attribute. If the data element has a variable primary data attribute, then the terminal may add an identification for the primary data attribute to the data element.

Embodiments consistent with the present disclosure identify data elements based on their attributes, and then present the data elements showing different identifications of the data attributes. Embodiments consistent with the present disclosure may thus display data elements with different attributes with distinction, and improve the accuracy of user data recognition.

FIG. 1 is a flow chart of a method for data presentation implemented by embodiments consistent with the present disclosure. The method describe in relation to FIG. 1 includes steps 101-103. In step 101, the system for data presentation may identify attributes of the data to be presented. The attributes may be primary data attributes or non-primary data attributes. In step 102, the system for data presentation may mark the data based on the attributes. In step 103, the system may present the data based on the markers.

In some embodiments consistent with the present disclosure, the step for marking data based their attributes includes the following steps. If one data element has a primary data attribute, then the system may add a primary data attribute identification to the data element. If one data element has a non-primary data attribute, then the system may chose not to add any identification to the data element.

In other embodiments consistent with the present disclosure, the step for marking data based their attributes includes the following steps. If one data element has a non-primary data attribute, then the system may add a non-primary data attribute identification to the data element. If one data element has a primary data attribute, then the system may chose not to add any identification to the data element.

In other embodiments consistent with the present disclosure, the step for marking data based their attributes includes the following steps. If one data element has a non-primary data attribute, then the system may add a non-primary data attribute identification to the data element. If one data element has a primary data attribute, then the system may add a primary identification to the data element.

Further, primary data attributes may include persistent primary data attribute and variable primary data attribute. If a data element has a primary data attribute, then the system for data presentation may determine whether the primary data attribute is a persistent primary data attribute or a variable primary data attribute. If the data element has a variable primary data attribute, then the system may add an identification for the primary data attribute to the data element.

Embodiments consistent with the present disclosure identify data elements based on their attributes, and then present the data elements showing different identifications of the data attributes. Embodiments consistent with the present disclosure may thus display data elements with different attributes with distinction, and improve the accuracy of user data recognition.

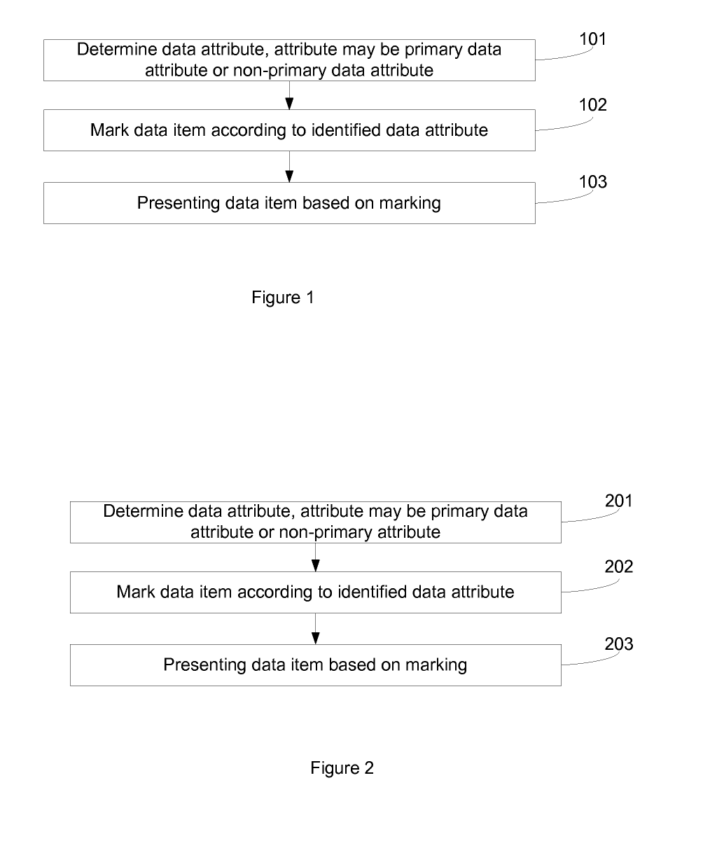

FIG. 2 is another flow chart for a method of data presentation implemented by embodiments consistent with the present disclosure. For the convenience of description, the example described in relation to FIG. 2 uses data elements of poker cards. A poker card data element may be a card of hearts element, a card of diamonds data element, a card of clubs data element, a card of spades data element, and a joker card data element. The example described in relation to FIG. 2 uses the five categories of poker card data elements to describe the method for data presentation. The primary data attributes and the non-primary data attributes of the poker cards may be defined by each application. As shown in FIG. 2, the method for data presentation includes steps 201-203.

In step 201, the system for data presentation may identify a data element's attributes. A poker card data element may include primary or non-primary data attributes. The system may define which data attribute is a primary data attribute. The system may define one data attribute as a primary data attribute and informing the user terminal about the identified primary data attribute. The user terminal may receive the information about the primary data attribute. When processing the poker card data elements, the user terminal may determine whether each data element has the primary data attribute. If so, the user terminal may identify the data element as one with the primary data attribute. If not, the user terminal may identify the data element as one with a non-primary data attribute. Alternatively, the system for data presentation may determine whether each data element has the primary data attribute. If so, the system may identify the data element as one with the primary data attribute. If not, the system may identify the data element as one with a non-primary data attribute.

For example, the system for data presentation may determine the hearts suit and the jokers to be primary data attributes. The system may send the information identifying the hearts suit and the jokers to be primary data attributes to a user terminal. The user terminal may receive the information identifying the primary data attributes. When the user terminal processes a poker card data element, if the data element is a card of hearts, then the user terminal may determine that this poker card data element has a primary data attribute. If a poker card data element is a card of spades, then the system may determine that the poker card data element has a non-primary data attribute.

In another example, the system for data presentation may determine the hearts suit and the jokers to be non-primary data attributes. The system may send the information identifying the hearts suit and the jokers to be non-primary data attributes to a user terminal. The user terminal may receive the information identifying the non-primary data attributes. When the user terminal processes a poker card data element, if the data element is card of hearts, then the user terminal may determine that this poker card data element has a non-primary data attribute. If a poker card data element is a card of spades, then the system may determine that the poker card data element has a primary data attribute.

In the above examples, it is obvious that the system for data presentation may select other suits as primary data attributes or non-primary data attributes. Further, other than the suits, the system for data presentation may also use other data attributes, such as card numbers, etc.

In step 202, the system for data presentation may mark the poker card data elements based on the data attributes. After step 201, the user terminal can determine whether each poker card has a primary or a non-primary data attribute. For each poker card, after the user terminal determines whether it has a primary or a non-primary data attribute, the user terminal may mark the poker card data element based on the determined attribute. The markers of the poker card may be carried using one of the following methods.

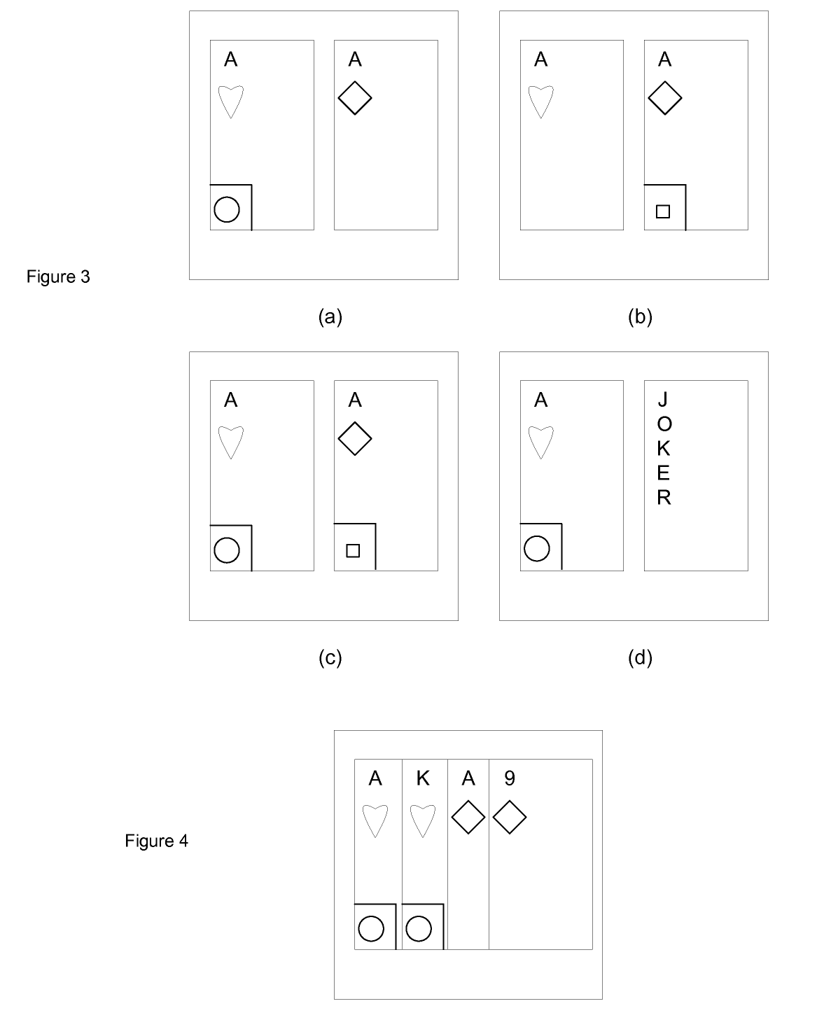

In some embodiments consistent with the present disclosure, if one poker card data element has a primary data attribute, then the system may add a primary data attribute identification to the data element. If one poker card data element has a non-primary data attribute, then the system may chose not to add any identification to the data element. For example, after step 201, the system for data presentation may determine the hearts suit and the jokers to be primary data attributes and the other suits (diamonds, clubs, and spades) to be non-primary data attributes. The user terminal may process a poker card data element A of hearts and a poker card data element A of diamonds. The user terminal may determine that the A of hearts card has a primary data attribute and add an identification of primary data attribute (at the left bottom corner of the card) to the A of hearts data element. The user terminal may determine that the A of diamonds card has a non-primary data attribute, and do not add any identification to the A of diamonds data element. FIG. 3(a) shows the data presentation described in this example.

In other embodiments consistent with the present disclosure, if one poker card data element has a non-primary data attribute, then the system may add a non-primary data attribute identification to the data element. If one poker card data element has a primary data attribute, then the system may chose not to add any identification to the data element. For example, after step 201, the system for data presentation may determine the hearts suit and the jokers to be primary data attributes and the other suits (diamonds, clubs, and spades) to be non-primary data attributes. The user terminal may process a poker card data element A of hearts and a poker card data element A of diamonds. The user terminal may determine that the A of hearts card has a primary data attribute and does not add any identification to the A of hearts. The user terminal may determine that the A of diamonds card has a non-primary data attribute, and add an identification of non-primary data attribute to the A of diamonds data element. FIG. 3(b) shows the data presentation described in this example.

In other embodiments consistent with the present disclosure, if one poker card data element has a non-primary data attribute, then the system may add a non-primary data attribute identification to the data element. If one poker card data element has a primary data attribute, then the system may add a primary identification to the data element. For example, after step 201, the system for data presentation may determine the hearts suit and the jokers to be primary data attributes and the other suits (diamonds, clubs, and spades) to be non-primary data attributes. The user terminal may process a poker card data element A of hearts and a poker card data element A of diamonds. The user terminal may determine that the A of hearts card has a primary data attribute and add an identification of primary data attribute to the A of hearts. The user terminal may determine that the A of diamonds card has a non-primary data attribute, and add an identification of non-primary data attribute to the A of diamonds data element. FIG. 3(c) shows the data presentation described in this example.

Further, primary data attributes may include persistent primary data attribute and variable primary data attribute. A data attribute that is always a primary data attribute may be referred to as the persistent primary data attribute. A data attribute that may be either a primary data attribute or a non-primary data attribute depending on different conditions may be referred to as the variable primary data attribute.

In the example described in step 201, the joker cards always have a primary data attribute. The joker cards data elements have persistent primary data attributes. The hearts cards may be defined as having a primary data attribute, as in this example, and may be defined as having a non-primary data attribute in other examples. Thus the hearts cards data element have variable data attributes.

After the system for data presentation determines that a poker card data element has a primary data attribute, it may further determine whether the data element has a persistent primary data attribute or a variable data attribute. If the poker card data element has a variable primary data attribute, the system may add an identification of the primary data attribute to the data element. The identifications of the variable primary data attribute are not limited to the ones presented in FIG. 3.

If a data element has a persistent primary data attribute, then the system for data presentation may determine not to add any identification of data attributes to the data elements. Alternatively, the system for data presentation may determine to add any identification of persistent primary data attributes to the data elements. The identifications of the persistent primary data attribute are not limited to the any specific formats.

In the example described above, the system for data presentation may determine the hearts suit and the jokers to be primary data attributes. The joker cards data elements have persistent primary data attributes. The hearts cards data elements have variable primary data attributes. In the example of a hearts card and a joker card. The system for data presentation may use one of the above methods of marking, i.e., adding a primary data attribute identification to the hearts card data element; not adding any identification to the joker card data element because the card has persistent primary data attribute. This data presentation is shown in FIG. 3(d).

The system for data presentation may add circles, change colors of cards, or add other shaped markers to a poker card as the identification of a primary or non-primary data attribute. The present disclosure does not limit the format of the identifications in any way. For example, an identification may be a star, a rectangle, or any other shapes. An identification may be located at the left upper corner or other positions on a poker card. The background color may be blue, green, or other colors. When a system for data presentation adds two types of identifications to data elements, it can choose different colors, shapes, etc., to mark different attributes, as long as the markings are distinguishable. For example, in FIG. 3(c), the identification of the primary data attribute and the non-primary data attribute are both located at the left lower corner of the cards. The identification for the primary data attribute is a circle, the identification for the non-primary data attribute is a square. The two identifications are distinguishable.

In step 203, the system for data presentation may present the poker card data elements with the proper identifications. In this step, there is no limitation as to how the data is presented on the user interface. For example, the data elements can be presented based on data attributes. The system may display all the poker cards with primary data attributes on the left side of the deck, and display all the poker cards with non-primary data attributes on the right side of the cards with primary data attributes. The system may also present the cards with non-primary data attributes in a random sequence.

Referring back to the example with the hearts poker cards and diamonds poker cards, the hearts cards have primary data attributes; the diamonds cards have non-primary data attributes. As shown in FIG. 4, the system for data presentation may display the hearts cards on the left, and the diamonds cards on the right.

With regard to the poker card example, embodiments consistent with the present disclosure may identify the data attributes of the poker cards so that a user can distinguish the cards with different attributes through the data presentation. As a result, an online poker game running by embodiments consistent with the present disclosure may present poker cards of trump suits differently from poker cards of the other suits. Embodiments consistent with the present disclosure thus enable a user to distinguish the trump suit cards quickly from the cards of the other suits in his hand as well as among the cards played by others. Embodiments consistent with the present disclosure improve user experience by decreasing the chance for a user to mistaken trump suit cards with other cards, which may cause him to give up points to his opponents or lose a game.

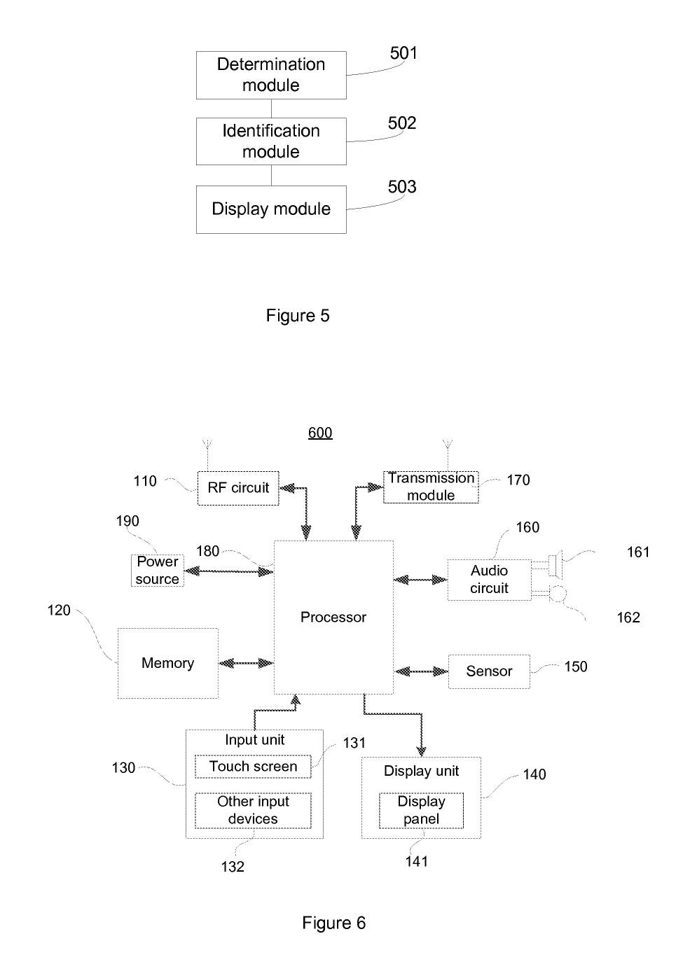

FIG. 5 shows an exemplary system for data presentation consistent with the present disclosure. The system for data presentation shown in FIG. 5 may be used to implement the examples described in relation to FIGS. 1 and 2. In FIG. 5, the system for data presentation may include a determination module 501, an identification module 502, and a display module 503. The determination module 501 may determine the data attributes of data elements to be presented. Data attributes may be primary or non-primary data attributes.

Embodiments consistent with the present disclosure may identify data based on their data attributes and distinguish data with different data attributes. Embodiments consistent with the present disclosure may make it easier for a user to distinguish data and therefore improve the accuracy of user data recognition.

It is apparent that poker card data elements are used as examples of the present disclosure. Embodiments consistent with the present disclosure may present other data elements using the same methodology. Embodiments consistent with the present disclosure do not limit the type of data elements presented. Embodiments consistent with the present disclosure also do not limit to presenting data according to the primary and non-primary data attributes. Other data attributes can also be used to present data.

In some embodiments consistent with the present disclosure, if one data element has a primary data attribute, then the identification module 502 may add a primary data attribute identification to the data element. If one data element has a non-primary data attribute, then the identification module 502 may chose not to add any identification to the data element.

In other embodiments consistent with the present disclosure, if one data element has a non-primary data attribute, then the identification module 502 may add a non-primary data attribute identification to the data element. If one data element has a primary data attribute, then the identification module 502 may chose not to add any identification to the data element.

In other embodiments consistent with the present disclosure, if one data element has a non-primary data attribute, then the identification module 502 may add a non-primary data attribute identification to the data element. If one data element has a primary data attribute, then the identification module 502 may add a primary identification to the data element.

Further, primary data attributes may include persistent primary data attribute and variable primary data attribute. If a data element has a primary data attribute, then the determination module 501 may determine whether the primary data attribute is a persistent primary data attribute or a variable primary data attribute. If the data element has a variable primary data attribute, then the identification module 502 may add an identification for the primary data attribute to the data element.

Embodiments consistent with the present disclosure identify data elements based on their attributes, and then present the data elements showing different identifications of the data attributes. Embodiments consistent with the present disclosure may thus display data elements with different attributes with distinction, and improve the accuracy of user data recognition.

Embodiments consistent with the present disclosure also provide a computer readable media, which may be part of the memory of a user terminal, or outside the user terminal. The computer readable media may store one or more computer programs. A processor may execute the one or more computer programs to implement methods for data presentation. The method includes the follow steps.

The system for data presentation may identify attributes of the data to be presented. The attributes may be primary data attributes or non-primary data attributes. The system for data presentation may mark the data based on the attributes. The system may present the data based on the markers.

In some embodiments consistent with the present disclosure, the step for marking data based their attributes includes the following steps. If one data element has a primary data attribute, then the system may add a primary data attribute identification to the data element. If one data element has a non-primary data attribute, then the system may chose not to add any identification to the data element.

In other embodiments consistent with the present disclosure, the step for marking data based their attributes includes the following steps. If one data element has a non-primary data attribute, then the system may add a non-primary data attribute identification to the data element. If one data element has a primary data attribute, then the system may chose not to add any identification to the data element.

In other embodiments consistent with the present disclosure, the step for marking data based their attributes includes the following steps. If one data element has a non-primary data attribute, then the system may add a non-primary data attribute identification to the data element. If one data element has a primary data attribute, then the system may add a primary identification to the data element.

Further, primary data attributes may include persistent primary data attribute and variable primary data attribute. If a data element has a primary data attribute, then the system for data presentation may determine whether the primary data attribute is a persistent primary data attribute or a variable primary data attribute. If the data element has a variable primary data attribute, then the system may add an identification for the primary data attribute to the data element.

Embodiments consistent with the present disclosure identify data elements based on their attributes, and then present the data elements showing different identifications of the data attributes. Embodiments consistent with the present disclosure may thus display data elements with different attributes with distinction, and improve the accuracy of user data recognition.

Moreover, embodiments consistent with the present disclosure provide a user interface. The user interface is presented on a user terminal. The user terminal includes a touch screen, a memory, and a processor to execute one or more programs. The processor may identify attributes of the data to be presented. The attributes may be primary data attributes or non-primary data attributes. The user interface may mark the data based on the attributes. The system may present the data based on the markers.

Embodiments consistent with the present disclosure identify data elements based on their attributes, and then present the data elements showing different identifications of the data attributes. Embodiments consistent with the present disclosure may thus display data elements with different attributes with distinction, and improve the accuracy of user data recognition.

Consistent with embodiments of the present disclosure, one or more non-transitory storage medium storing a computer program are provided to implement the system and method for displaying data elements on a user interface. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be semiconductor storage medium, such as DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, various systems for presenting data on a user interface may be implemented. For example, an online trick tracking card game, such as Shengji (Upgrade) or TuoLaJi (Tractor) may use embodiments consistent with the present disclosure to present the dominant suit or the trump suit (jokers and the dominant suit) cards. For example, in one round, if the Queen of Spades is dominant, then the order of the cards is:

(1) Red Jokers

(2) Black Jokers

(3) Q

[symbol]

(4) Queen of any other suit

(5) A [symbol] , K [symbol] , J [symbol] , 10 [symbol] , 9 [symbol] , 8 [symbol] , 7 [symbol] , 6 [symbol] , 5 [symbol] , 4 [symbol] , 3 [symbol] , 2

[symbol]

(6) Cards in other suits

Cards in categories 1-5 are trump cards. Embodiments consistent with the present disclosure may mark those cards with a marker (e.g., a round circle on the left bottom corner of the card) so that it would be easier for a player to read the cards during the game. Alternatively, embodiments consistent with the present disclosure may only mark cards in categories 3-5 (variable primary data attribute) with a marker. Because the joker cards are always trump cards (persistent primary data attribute), the player may not need those to be marked to recognize them as the trump cards.

By presenting data using embodiments of the present disclosure, a user terminal may provide a user interface with better distinction among different categories of data and with improved user experience.

What is claimed is:

1. A method for presenting data elements on a user interface, comprising:
determining a data attribute of a data element, the data attribute being a primary data attribute or a non-primary data attribute;
identifying the data element based on the data attribute; and
displaying the data element based on the identification of the data attribute.

2. The method according to claim 1, wherein identifying the data element based on the data attribute further comprises:
adding an identification to the data element if the data attribute is a primary data attribute.

3. The method according to claim 1, wherein identifying the data element based on the data attribute further comprises:
adding an identification to the data element if the data attribute is a non-primary data attribute.

4. The method according to claim 1, wherein identifying the data element based on the data attribute further comprises:
adding an identification to the data element if the data attribute is a primary data attribute; and
adding another identification to the data element if the data attribute is a non-primary data attribute.

5. The method according to claim 2, wherein the primary data attribute is a persistent primary data attribute or a variable primary data attribute.

6. The method according claim 4, wherein adding an identification to the data element if the data attribute is a primary data attribute further comprises:
determining whether the primary data attribute is a variable primary data attribute; and
adding the identification to the data element if the data attribute is a variable primary data attribute.

7. A system for presenting data elements on a user interface, comprising:
a determination module configured to determine a data attribute of a data element, the data attribute being a primary data attribute or a non-primary data attribute;
an identification module configured to identify the data element based on the data attribute; and
a display module configured to display the data element based on the identification of the data attribute.

8. The system according to claim 7, wherein the identification module is further configured to add an identification to the data element if the data attribute is a primary data attribute.

9. The system according to claim 7, wherein the identification module is further configured to add an identification to the data element if the data attribute is a non-primary data attribute.

10. The system according to claim 7, wherein the identification module is further configured to add an identification to the data element if the data attribute is a primary data attribute; and
add another identification to the data element if the data attribute is a non-primary data attribute.

11. The system according to claim 8, wherein the primary data attribute is a persistent primary data attribute or a variable primary data attribute.

12. The system according to claim 10, wherein the identification module is further configured to determine whether the primary data attribute is a variable primary data attribute;
and add an identification to the data element if the data attribute is a variable primary data attribute.

13. A system for presenting poker cards on a user interface of an online poker game, comprising:
a determination module configured to determine a data attribute of a poker card data element, the data attribute being a trump suit or one of other suits;
an identification module configured to identify the poker card data element based on the data attribute; and
a display module configured to display the poker card data element based on the identification of the data attribute.

14. The system according to claim 13, wherein the identification module is further configured to add a marker to the poker card data element if the data attribute is the trump suit.

15. The system according to claim 14, wherein the display module is further configured to display the marker on the poker card on the user interface.

16. The method according to claim 4, wherein the primary data attribute is a persistent primary data attribute or a variable primary data attribute.

17. The system according to claim 10, wherein the primary data attribute is a persistent primary data attribute or a variable primary data attribute.
